(19) United States
(12) Patent Application Publication
(10) Pub. No.: US 2013/0113990 A1
(43) Pub. Date: May 9, 2013

(54) DOCUMENT SCANNER

(71) Applicants: Andrew Roy Cullum, Dry Dayton (GB); Graham James Ohn Tinn, St. Ives (GB); Jianjun Zuo, Jiangsu (CN); Feng Li, Jiangsu (CN); Peng Jiang, Jiangsu (CN); David Badger, Yaxley (GB); Jun Wang, Jiangsu (CN)

(72) Inventors: Andrew Roy Cullum, Dry Dayton (GB); Graham James Ohn Tinn, St. Ives (GB); Jianjun Zuo, Jiangsu (CN); Feng Li, Jiangsu (CN); Peng Jiang, Jiangsu (CN); David Badger, Yaxley (GB); Jun Wang, Jiangsu (CN)

(73) Assignee: Colortrac Limited, St. Ives ,Huntingdon (GB)

(21) Appl. No.: 13/698,357

(22) PCT Filed: May 27, 2010
(86) PCT No.: PCT/CN2010/000755

§ 371 Date: Jan. 14, 2013

(51) Int. Cl. H04N 1/03

(52) U.S. Cl. CPC H04N 1/03
USPC 348/474

(57) ABSTRACT

A document scanner comprises first and second image sensor units (30,32), each having an array of electromagnetic radiation detectors (44) situated adjacent circuitry (42) for operating the detectors. A scanning mechanism (70,72,76,78,80) causes relative movement between the detectors and a document to cause the detectors to scan the document along a scanning direction. The array of detectors of the first unit (30) is situated ahead of the array of detectors of the second unit (32) in said scanning direction, the orientation of the detectors of the first unit with respect to their circuitry thus being the reverse of that of the detectors of the second unit, thereby to reduce the distance, in the scanning direction, between the two arrays.

### FIELD OF THE INVENTION

This invention relates to document scanners.

### BACKGROUND TO THE INVENTION

The invention is particularly applicable to large format document scanners, i.e. those for scanning documents of widths greater than approximately 11 inches (30 centimetres). Typically, a document scanner has an image detection system which obtains image data for a single image line, and a scanning mechanism for causing relative movement between the detection system and a document so as to cause the image line to be swept over the surface of the document. This captures data representative of a succession of scan lines for the document, which can be reconstructed to provide an image of the document.

The image detection system of a document scanner will include an image sensor unit having an array of detectors, for example charge coupled devices (CCDs) or CMOS detectors. In the course of manufacture of the devices, there is a risk of failure of the device which increases with the number of detectors in the array, so that sensor units with arrays of a large number of detectors are more expensive to manufacture than devices which have a smaller number of detectors in their arrays.

Consequently, it is known for large document scanners to use a number of image sensor units, each of which captures data for a respective portion of each scan line. In order to ensure that corresponding portions can be assembled to provide a single continuous scan line, it is known for the ends of neighbouring portions to overlap, so that each portion has a slight overlap with one or two other portions, dependent on whether the portion is from an end or the middle of the scan line.

In a known method of generating image data representative of the entire scan line from the data from a plurality of imaging devices, an initial and/or terminal portion of the image data from each device, corresponding to the slight overlap or overlaps, is discarded and the remainders of the image data are concatenated with one another.

A relatively compact and low cost image sensor unit that can be used as an imaging device is a contact image sensor (CIS). This type of device has a linear array of image detectors, such as charge coupled devices or CMOS devices, covering an area similar to the area of the scan line portion associated with the device. This correspondence between the area of the detectors and the area to be scanned by the device means that bulky and/or expensive optical scaling systems are not needed. However, the need for an overlap between neighbouring scan line portions requires that the contact image sensors are arranged in a physically overlapping relationship in the direction in which the documents are scanned. Because the detectors of the devices have operating circuitry that needs to be positioned adjacent to the detectors, there is a limit to the minimum distance between the adjacent scan line portions in the scanning direction.

This means that the scan line portions must be re-matched in the direction of scanning, either in the electronics of the scanner or in software. Any inconsistencies in the motion of the paper across the CIS units can result in an error in stitching the images front the CIS units together.

### SUMMARY OF THE INVENTION

According to the invention, there is provided a document scanner comprising first and second image sensor units, each having an array of electromagnetic radiation detectors situated adjacent circuitry for operating the detectors; the scanner further comprising a scanning mechanism for causing relative movement between the detectors and a document to cause the detectors to scan the document along a scanning direction, the array of detectors of the first unit being situated ahead of the array of detectors of the second unit in said scanning direction, wherein the orientation of the detectors of the first unit with respect to their circuitry is the reverse of that of the detectors of the second unit, thereby to reduce the distance, in the scanning direction, between the two arrays.

Preferably, the arrays are linear arrays, each of which is operable to generate image data representative of a respective portion of each of a succession of scan lines of the document, wherein the areas imaged by the two arrays partially overlap.

In each unit, positioning the circuitry adjacent to the detectors, means that the array of detectors is generally offset, in a direction parallel to the scanning direction, towards one edge, the closer edge, of the unit. The or most of the circuitry is situated between the array and the unit's other, further edge. Conventionally, the units are arranged with the same orientation to each other, but since the units will overlap, the distance between the two arrays in the scanning direction cannot be less than the sum of the distance between one of the arrays and the respective further edge and the distance between the other array and the respective closer edge.

However, since one of the units of the scanner in accordance with the invention has a reversed orientation relative to the other unit, the two units can be placed in an overlapping configuration in which the distance between the two arrays of the detectors can be close to the sum of the distances between the arrays and their corresponding closer edges.

Preferably, the circuitry of each unit is situated wholly or substantially wholly to one side of the unit's linear array of detectors.

This feature allows the distance between each array and its respective closer edge to be minimised, and thus facilitates said reduction in the distance, in the scanning direction, between the arrays of detectors.

Conveniently, the circuitry for each unit is provided on a respective printed circuit board on which that unit's array of detectors is mounted.

Preferably, the circuitry for the detectors of the first unit is situated ahead of those detectors, in the scanning direction, whilst circuitry for the detectors of the second unit is situated behind that unit in the scanning direction.

It is within the scope of the invention for the scanning mechanism to move the units through the scanner in the scanning direction to scan the document held stationary thereon, but preferably the units are, in use, stationary with respect to the scanner, the scanning mechanism being operable to move the document past the detectors in the opposite direction to the scanning direction.

Preferably, each of the first and second units comprises a respective contact image sensor.

Such sensors have low power requirements and are relatively cheap and compact.

Preferably, the scanner has a common light source, for example a fluorescent tube or array of light emitting diodes, for providing illumination for the images detected by the contacting sensors.

The common light source avoids the need for each contact image sensor to have its own source, and therefore enables the sensors to be of a more compact design than conventional contact image sensors.

In addition, one disadvantage of using known contact image sensors (each of which has its own light source) is that the light source for one of the sensors may emit light of a different colour and/or intensity from the light emitted by the other source. This can lead to linear artefacts in the interface between the portions of the scanned image obtained by the two units. The human eye can be highly sensitive to such artefacts. However, if the units share a common light source, then sharp changes of intensity and/or colour of light at the interface can be avoided.

In that connection, if the source comprises an array of LEDs, it preferably also includes a diffuser for diffusing and mixing the light emitted by individual LEDs. Such a diffuser could, for example, form part of a light guide.

Preferably, each array of detectors has one or more associated lenses for focussing light from a respective imaging point onto each detector in the array. The lens or lenses of the first and second unit being angled towards a common line which is flanked by the two detector arrays and runs perpendicular to the scanning direction.

Thus, the lens or lenses of the first unit are angled rearwardly, whilst the lens or lenses of the second unit are angled forwardly with respect to the scanning direction, the lenses of the two units thus being toed in towards the common line so that the distance between the scan line portions, in the scanning direction, is less than that between the arrays of detectors.

Preferably, the orientation of the lenses is such that the image points for the sensors of both arrays lies substantially on the common line, which thus, in use, constitutes a common, continuous scan line of the document.

Preferably, where the detectors are arranged in linear arrays, the lens or lenses for each detector array comprise a respective linear array of rod lenses, each rod lens being associated with a respective detector.

The two units of the scanner may to advantage be two of three or more such units, the orientation of detectors of each unit, relative to their circuitry, being the reverse of that of its neighbouring unit or units and the positions or the units on the scanning direction alternating between a position corresponding to the position of the first unit, and a position corresponding to that of the second unit. Thus the units are arranged in a staggered configuration.

### BRIEF DESCRIPTION OF THE DRAWINGS

Two embodiments of scanner in accordance with the invention will now be described, by way of example only, and with reference to the accompanying drawings in which:

FIG. 1 is a plan view of part of a scanner in accordance with the prior art;

FIG. 2 shows a portion of a document to be scanned by the scanner;

FIG. 3 shows how variations in the rate of feed of documents through the scanner can lead to problems in stitching together the portions of scan lines that constitute the image of the document;

FIG. 4 is a view, corresponding to FIG. 1, of part of the first embodiment of scanner in accordance with the invention;

FIG. 5 is a sectional view along the line V-V of FIG. 4;

FIG. 6 is a sectional side view of the first embodiment of scanner in accordance with the invention;

FIG. 7 is a view, corresponding to FIG. 5, of part of a second embodiment of scanner in accordance with the invention; and

FIG. 8 is a view, corresponding to FIG. 4, of part of the second embodiment of scanner.

### DETAILED DESCRIPTION

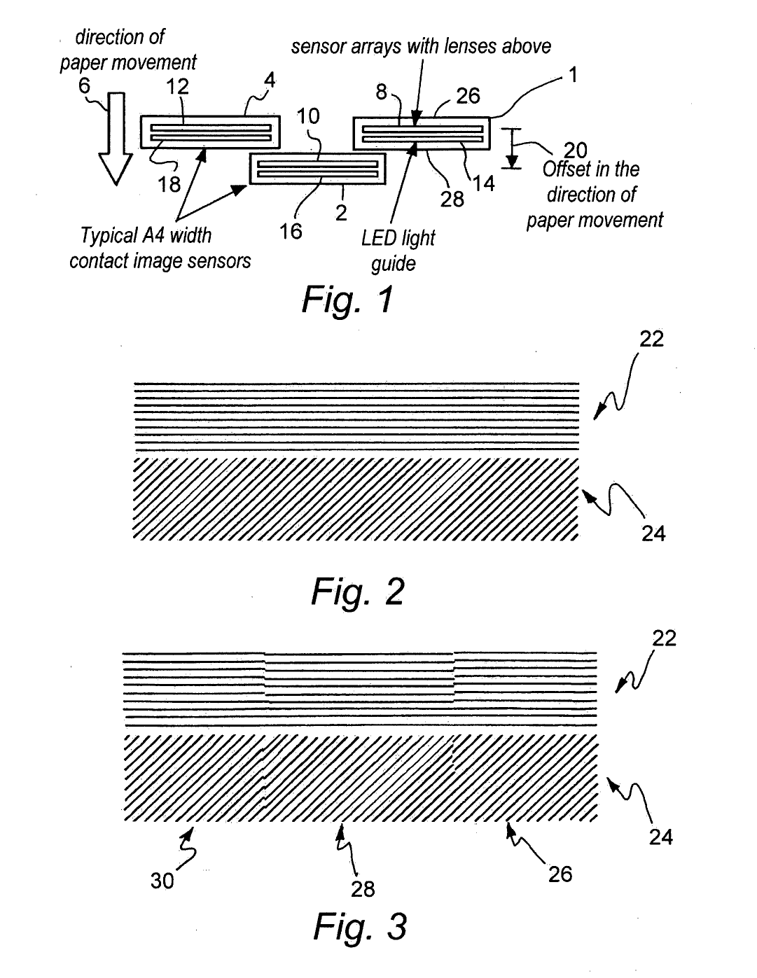

The known large format document scanner of FIG. 1 has first, second and third contact image sensors respectively referenced 1, 2 and 4 which are situated beneath a transparent plate (not shown) over which a document to be scanned is fed in the direction indicated by the arrow 6. The sensors 1, 2 and 4 face upwardly, and each has a linear array of rod lenses that focuses the image of successive scan line portions of the document on an underlying linear array of photo detectors. The lenses of the first sensor 1 are referenced 8, whilst the lenses of the second and third sensors are respectively referenced 10 and 12. Each of the sensors 1, 2 and 4 also have onboard light sources, respectively referenced 14, 16 and 18, each of which illuminates the portion of the document to be imaged by the respective array of sensors.

As can be seen from FIG. 1, the use of more than one sensor enables the width of document that can be scanned to be larger than the length of an individual detector array of any one of the sensors. Each sensor will gather data for a succession of scan line portions of a document being fed through the scanner, the portions then being “stitched” together by computer software to yield a succession of composite scan lines that constitute the image of the scanned document. The direction in which the document is scanned will be opposite that indicated by the arrow 6.

As can be seen from FIG. 1, the lens arrays 8, 10 and 12 do not butt up against the very edges of the sensors, so it is not possible simply to have the sensors arranged side-by-side, otherwise there would be gaps between the adjacent scan line portions. Consequently, the sensors 1, 2 and 4 are arranged in the staggered formation shown in FIG. 1, in which there is some overlap between scan line portions, and in which the first sensor 1 and third sensor 4 are situated ahead of the second sensor 2, in the scanning direction. Consequently, the left and right-hand portions of a given scan line are captured by the sensors 1 and 4 before the central part of the same scan line is captured by the sensor 2. Once the document is passed through the scanner, the scan line portions are analysed by the computer software which identifies the portion of the scan line captured by the sensor 1 that overlaps with that captured by the sensor 2 and discards one of those overlapping parts, and performs the same process in relation to the overlapping parts of the scan line portions captured by the sensors 2 and 4. The software then stitches together the three scan line portions to create a composite scan line for the document. This stitching together has to take into account the delay in the capture of a given portion by the sensor 2 compared with the time of capture of the corresponding portions by the sensors 1 and 4.

However, this delay cannot properly be taken into account if there is a variation in the movement of the document through the scanner, specifically as the portion of the document to be imaged by a scan line which has been partially captured by the sensors 4 and 8 then traverses the gap, the distance of which is indicated by the arrow 20 in the scanning direction between the lenses 8, 12 and the lenses 10. This can lead to stitching errors so that a document having a pattern as shown in FIG. 2, for example yields the erroneous image shown in FIG. 3. As can be seen from FIGS. 2 and 3 the document has a pattern of horizontal lines 22 and diagonal lines 24. In the final document image, references 26, 28 and 30 indicate the portions of image captured by the sensors 1, 2 and 4 respectively. Because of a discontinuity in the feed of the document, the portion 28 is out of register with the portions 26 and 30, so that the horizontal and diagonal lines lose continuity (stitch) periodically at the interfaces between the portions 26, 28 and 30.

The risk of this sort of error occurring increases with the distance indicated by the arrow 20. However, the sensors under the lenses 8, 10 and 12 are mounted on circuit boards which extend to one side of the lenses and detectors, and under the light sources 14, 16 and 18. This means that the detectors and lenses are offset towards a closer edge of each unit (the edge referenced 26 in FIG. 1), the other edge, the further edge being indicated by the reference numeral 28. As can be seen from FIG. 1, the sensors 1,2 and 4 all have the same orientation so that the further edge 28 is the edge of the sensor 1 which is adjacent the upper edge of sensor 2. Thus the offset of the detectors and lenses 8 limits the minimum possible distance indicated by the arrow 20.

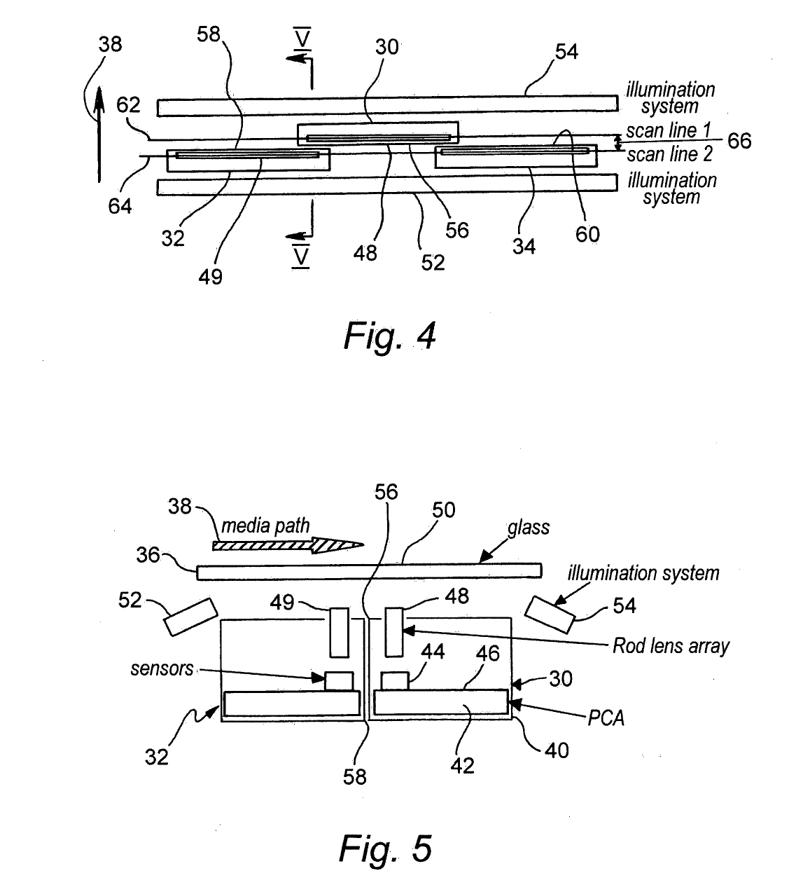

With reference to FIGS. 4-6, the first embodiment of the scanner in accordance with the invention also has a staggered arrangement of three contact scanners, a second sensor 30 flanked by first and third sensors 32 and 34. The three sensors 30, 32 and 34 are held stationary within the scanner underneath a glass plate 36 over which a document can be fed by a scanning mechanism (described below) in the direction indicated by the arrow 38. Thus, the document will be scanned in the direction opposite to that of the arrow 38, so that the first sensor 30 is situated ahead of the second and third sensors 32 and 34 in the scanning direction.

With reference to FIG. 5, the sensor 30 comprises a printed circuit assembly 40 in the form of a printed circuit board 42 on which is mounted a linear array of electromagnetic detectors 44 in the form of a row of CMOS devices for detecting visible light. The circuitry for providing the power to operate the detectors and for enabling the detectors to be interrogated to obtain data representative of the intensity of light incident on each detector is situated on the portion 46 of the printed circuit board 42 to the right-hand side of the array of detectors 44, as viewed in FIG. 5.

The detectors 44 are situated beneath a linear rod lens array 48 constituted by a line of glass rods, each of which is in registry with a respective detector so as to direct light from a respective imaging point, such as the point 50, onto that detector. The size of each detector is substantially the same as the size of the associated imaging point, so that no reduction or magnification of the imaging points has to be performed by the lenses.

The sensors 32 and 34 are of identical construction to the sensor 30, and so are not described in detail. However, the lens array for the sensor 32 is denoted by reference numeral 49.

All three of the sensors are flanked by two common light sources 52 and 54, each of which is of a similar construction to the light sources used by conventional contact image sensors. In the present examples, each of the sources 52 and 52 comprises an arrangement or red, green and blue LEDs within an elongate light guide which conveys light from the LEDs along its length and also diffuses the light to give an even illumination of the light of different colours.

The light sources 52 and 54 provide illumination for each of the four scan lines of a document detected by the sensors 30, 32 and 34 acting in combination.

As with the contact image sensors of the conventional scanner, the lens arrays of the contact image sensors 30, 32 and 34 arc offset towards respective closer edges 56, 58 and 60 of the units. As can be seen from the Figures, the orientation of the sensor 30 is the reverse of that of the sensors 32 and 34, so that the portion 46 of the circuit board 42 is behind the array of detectors 44 in the scanning direction, whereas the corresponding portions of the circuit boards of the detectors 32 and 34 are ahead of the arrays of detectors of those sensors in the scanning direction. The sensors are thus orientated with the closer edges of neighbouring sensors facing each other in the areas where the sensors overlap. The imaging points of each array of detectors constitutes a respective imaging line from which data representative of a succession of scan line portions associated with the sensor is obtained. Reference numeral 62 denotes the axis of the imaging line associated with the sensor 30, whilst reference numeral 66 denotes the axis of the aligned imaging lines associated with the sensors 32 and 34. The arrow 64 indicates the difference between the lines 62 and 64 which, by virtue of the alternating orientation of the sensors is considerably shorter than the distance denoted by the arrow 20 i.e. the distance between the corresponding axes in the prior art scanner.

The scanner processes and combines the data of the sensors 30, 32 and 34 in the same way as happens with the prior art scanner, assembling a succession of scan lines for a document from the scan line portions captured by the sensors as the document passes through the scanner. However, since the distance between the imaging lines of the sensor 30 and those of the sensors 32 and 34 are much smaller than the corresponding distance associated with the prior art, the risk of errors in stitching together the portions is reduced.

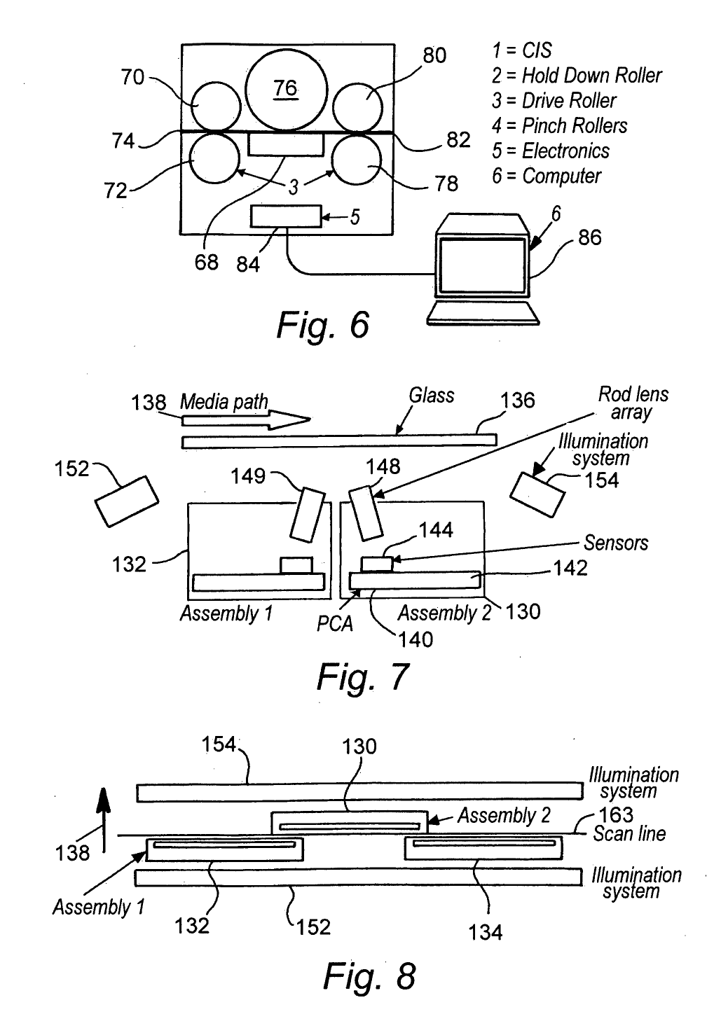

FIG. 6 is a sectional side view showing the components of FIGS. 4 and 5 (generally referenced 68) in the scanner. The scanning mechanism of the scanner comprises an upstream drive roller 72 which co-operates with a pinch roller 70 to receive a document fed into an entrance 74 of the scanner. The drive roller 72 propels the document under a hold-down roller 76 which holds the document against the plate 36 to ensure good contact between the document and the glass plate showing the imaging process. A downstream drive roller 78 and associated pinch roller 80 then receive the document and guide and propel it out of an exit 82 of the scanner. The rollers 70, 72, 76, 78 and 80 constitute the scanning mechanism. Data retrieved from the sensors is processed by electronics 84 from which the data is then fed to a computer 86 for constituting the scanned image of the document. It will be appreciated that other arrangements of elements for driving the document through the scanner in a sufficiently controlled manner may be used as a scanning mechanism.

Turning to FIGS. 7 and 8, the second embodiment of scanner in accordance with the invention has many features which are substantially the same as the corresponding features of the first embodiment of scanner in accordance with the invention, and these are therefore denoted by the reference numerals used in the other Figures, raised by 100. Thus the scanner has three contact image sensors 130, 132 and 134 which scan a document that is illuminated by two common light sources 152 and 154. Indeed the only feature of difference in the second embodiment is the orientation of the arrays of rod lenses. More specifically, the array 148 for the sensor 130 is angled forwardly with respect to the scanning direction, whilst the rod arrays for the sensors 32 and 34 are angled in the opposite direction (i.e. the same direction as the feed direction for a document). The angling is such that, consequently, the three imaging lines associated with the sensors all lie on a common axis, and therefore define a composite imaging line 163.

Thus, in this case, all portions of a given scan line are imaged simultaneously, and the risk of any errors in stitching together the portions is thereby minimised.

Typically, the angle between the arrays of rod lenses will be as small as possible (approximately 10 degrees), but is related to the focal distances and thicknesses of the lenses. The maximum permissible angle is only limited by reflection effects of the glass and illumination problems.

Each of the contact image sensors (CTS), of either embodiment, may be the size of standard A4 size CIS. The number of sensors provided in the scanner, in a staggered formation, is dependent upon the desired width of scan. Typically, five assemblies arranged in staggered, alternating orientation formation would be required for a scanner to provide a scan width of 40 inches.

It will be understood that other variations may be made to the scanners without departing from the scope of the invention. For example, the two light sources could be replaced by a single light source on one side of the contact image sensors or by a respective on-board illumination system on each sensor.

1. A document scanner comprising first and second image sensor units, each image sensor unit having an array of electromagnetic radiation detectors situated adjacent circuitry for operating the electromagnetic radiation detectors; the document scanner further comprising a scanning mechanism for causing relative movement between the electromagnetic radiation detectors and a document to cause the electromagnetic radiation detectors to scan the document along a scanning direction, the array of electromagnetic radiation detectors of the first image sensor unit being situated ahead of the array of electromagnetic radiation detectors of the second image sensor unit in said scanning direction, wherein the orientation of the electromagnetic radiation detectors of the first image sensor unit with respect to their circuitry is the reverse of that of the electromagnetic radiation detectors of the second image sensor unit with respect to their circuitry.

2. A document scanner according to claim 1 in which the arrays of the first and second image sensor units are linear arrays, each of which is operable to obtain image data representative of a respective portion of each of a succession of scan lines for the document, wherein the portions partially overlap so that, in use, part of the document is imaged by both arrays of electromagnetic radiation detectors.

3. A document scanner according to claim 2 in which the circuitry of each image sensor unit is situated wholly or substantially wholly to one side of the image sensor unit's linear array of electromagnetic radiation detectors.

4. A document scanner according to claim 3 in which the circuitry for each image sensor unit is provided on a respective printed circuit board on which that image sensor unit's array of electromagnetic radiation detectors is mounted.

5. A document scanner according to claim 4 in which the circuitry for the electromagnetic radiation detectors of the first image sensor unit is situated ahead of those electromagnetic radiation detectors of the first image sensor in the scanning direction, whilst the circuitry for the electromagnetic radiation detectors of the second image sensor unit is situated behind those electromagnetic radiation detectors of the second image unit in the scanning direction.

6. A document scanner according to claim 1 in which the image sensor units are held stationary with respect to the document scanner, the scanning mechanism being operable to move the document past the electromagnetic radiation detectors in an opposite direction to the scanning direction.

7. A document scanner according to claim 1 in which each of the first and second image sensor units comprises a respective contact image sensor.

8. A document scanner according to claim 7 in which the document scanner has a common light source for providing illumination for the images detected by both contact image sensors.

9. A document scanner according to claim 1 in which each array of electromagnetic radiation detectors has one or more associated lenses for focussing light from a respective imaging point onto each electromagnetic radiation detector in the respective array of electromagnetic radiation detectors, the one or more associated lenses of the first and second image sensor unit being angled towards a common line which is flanked by the two arrays of electromagnetic radiation detectors and runs perpendicular to the scanning direction.

10. A document scanner according to claim 9 in which the orientation of the one or more associated lenses is such that the imaging points of both arrays of electromagnetic radiation detectors lie substantially on the common line which thereby constitutes a common continuous imaging line from which data representative of a succession of scan lines is obtained.

11. A document scanner according to claim 10 in which the electromagnetic radiation detectors are arranged in linear arrays and the one or more associated lenses for each array of electromagnetic radiation detectors comprises a respective linear array of rod lenses.

12. A document scanner according to claim 1 in which the two image sensor units are two of three or more such image sensor units, the orientation of the electromagnetic detectors of each image sensor unit is relative to their circuitry, being the reverse of that of its neighbouring image sensor unit or units and the position of the image sensor units in the scanning direction alternating between a position corresponding to the position of the first image sensor unit and a position corresponding to that of the second image sensor unit.

13. A document scanner, comprising:
a first image sensor unit including a first array of electromagnetic radiation detectors situated adjacent first circuitry for operating the first array of electromagnetic radiation detectors;
a second image sensor unit including a second array of electromagnetic radiation detectors situated adjacent second circuitry for operating the second array of electromagnetic radiation detectors; and
a scanning mechanism for causing relative movement between a document and the first and second arrays of electromagnetic radiation detectors to cause the first and second arrays of electromagnetic radiation detectors to scan the document along a scanning direction;
wherein the first array of electromagnetic radiation detectors is situated ahead of the second array of electromagnetic radiation detectors in the scanning direction, and wherein an orientation of the first array of electromagnetic radiation detectors with respect to the first circuitry is the reverse of that of an orientation of the second array of electromagnetic radiation detectors with respect to the second circuitry; and
wherein the first and second arrays of electromagnetic radiation detectors are operable to obtain image data representative of a respective portion of each of a succession of scan lines for the document, wherein the portions partially overlap so that, in use, part of the document is imaged by both the first and second arrays of electromagnetic radiation detectors.

14. A document scanner according to claim 13, wherein the first circuitry is situated at least substantially to one side of the first array of electromagnetic radiation detectors, and wherein the second circuitry is situated at least substantially to one side of the second array of electromagnetic radiation detectors.

15. A document scanner according to claim 14, wherein the first circuitry is situated ahead of the first array of electromagnetic radiation detectors in the scanning direction, and wherein the second circuitry is situated behind the second array of electromagnetic radiation detectors in the scanning direction.

16. A document scanner according to claim 13, wherein the first and second arrays of electromagnetic radiation detectors each has one or more associated lenses for focusing light from a respective imaging point onto each electromagnetic radiation detector in the respective array of electromagnetic radiation detectors, the one or more associated lenses of the first and second image sensor units being angled towards a common line which is flanked by the first and second arrays of electromagnetic radiation detectors and runs perpendicular to the scanning direction.

17. A document scanner according to claim 16, wherein the orientation of the one or more associated lenses is such that the imaging points of both the first and second arrays of electromagnetic radiation detectors lie substantially on the common line which thereby constitutes a common continuous imaging line from which data representative of a succession of scan lines is obtained.

18. A document scanner according to claim 17, wherein the electromagnetic radiation detectors of the first array of electromagnetic radiation detectors are arranged in a first linear array, wherein the electromagnetic radiation detectors of the second array of electromagnetic radiation detectors are arranged in a second linear array, and wherein the one or more associated lenses for each of the first and second linear arrays comprises a respective linear array of rod lenses.

19. A document scanner according to claim 13, wherein the document scanner further comprises:
a third image sensor unit including a third array of electromagnetic radiation detectors situated adjacent third circuitry for operating the third array of electromagnetic radiation detectors, wherein the third array of electromagnetic radiation detectors is situated ahead of the second array of electromagnetic radiation detectors in the scanning direction, wherein the third image sensor unit is positioned generally opposite the first image sensor unit relative to the second image sensor unit, and wherein an orientation of the third array of electromagnetic radiation detectors with respect to the third circuitry is the same as the orientation of the first array of electromagnetic radiation detectors with respect to the first circuitry.

20. A document scanner kit, comprising:
the document scanner of claim 13; and
non-transitory computer readable storage media including computer-executable instructions that, when executed, direct a computer to:
identify portions of the scan lines captured by both the first and second arrays of electromagnetic radiation detectors; and
create a composite scan line for the document.
